(19) United States
(12) Patent Application Publication
(10) Pub. No.: US 2017/0224165 A1
(43) Pub. Date: Aug. 10, 2017

(54) DEVICE AND METHOD FOR PROCESSING FOODS

(71) Applicant: Betty Bossi AG, Zurich (CH)

(72) Inventor: Valentin Engler, Zurich (CH)

(73) Assignee: Betty Bossi AG, Zurich (CH)

(21) Appl. No.: 15/413,636

(22) Filed: Jan. 24, 2017

(30) Foreign Application Priority Data
Feb. 8, 2016 (CH) 00167/16

(51) Int. Cl. A47J 43/04; B26D 1/00; B26D 3/11

(52) U.S. Cl. CPC A47J 43/04; B26D 3/11; B26D 1/0006; B26D 2001/0073

(57) ABSTRACT

A device (1) for processing foods includes a container (2) containing a dividing element (3, 4) for cutting through a food in order to produce a strip-shaped, spiral cut material, a housing (5) for accommodating the container (2), and a supporting element (6) for supporting the food, wherein the container (2) is rotatable in the housing (5). An intermediate space (7) is provided between the supporting element (6) and the dividing element (3, 4) in order to clamp the food, wherein the dividing element (3, 4) for cutting through the food is connected to the container (2), and therefore the cut material can be produced by the dividing element (3, 4) by a rotational movement of the container (2) and can be guided into an interior space (24) of the container (2).

### INCORPORATION BY REFERENCE

The following documents are incorporated herein by reference as if fully set forth: Swiss Patent Application No. 00167/16, filed Feb. 8, 2016.

### BACKGROUND

The invention relates to a device and to a method for processing foods. In particular, the device serves for processing fruit or vegetables. The device serves in particular for chopping up fruit or vegetables.

A device for producing spiral strips of vegetables, to which end, for example, cucumbers or carrots can be used, is known from the prior art. This device consists of a cylindrical receiving container for the vegetable and a cylindrical placement element. The cylindrical placement element has a placement surface for the vegetable, and also an exterior thread running on the cylinder casing below the placement surface. The placement surface has a plurality of holding elements which form small cutting edges which engage in the vegetable and position same non-rotatably on the placement surface. The cylindrical receiving container is open at one end and has an interior thread running on the interior wall of the cylinder casing. The interior thread is intended for engagement in the exterior thread of the placement element. The receiving container is positioned onto the placement element and its interior thread engages in the exterior thread of the placement element. The opposite end of the receiving container is closed by a lid element which includes at least one cutting knife.

In the operating state, the vegetable is located on the placement surface and is accommodated in the interior space of the receiving container. When the receiving container is set into a rotational movement, that is to say screwed onto the exterior thread of the placement element, the vegetable comes into contact with the encircling cutting knife and is cut in such a manner that a spiral strip is produced. If a plurality of cutting knives are arranged in the lid element, a plurality of spiral strips of this type can be produced.

The spiral vegetable strip can be positioned directly on a plate or in a dish, for example in order to produce a salad.

However, it has proven disadvantageous during the operation that a long period elapses before a portion of vegetables is made ready in this manner, and therefore the user has to allow for some time. In addition, depending on the consistency of the vegetable and the configuration of the cutting edges of the placement element, the vegetable may not be grasped by the cutting edges and may not undertake the rotational movement therewith. If the diameter of the vegetable is virtually the same size as the internal diameter of the receiving container, the vegetable may tilt and become stuck. The vegetable is then no longer supplied to the cutting knife, and the vegetable is pressed together to form a mushy mass in the interior space of the receiving container as the rotational movement continues, and the desired chopping up of the food into small pieces does not occur. A disadvantage of some existing devices is also the presence of an open blade which constitutes a risk of injury. There is therefore the need for a device for processing foods, in particular fruit or vegetables, which permits the food to be chopped up in the desired form in a more reliable manner for a plurality of different types of fruit or vegetable.

### SUMMARY

It is therefore the object of the invention to provide a device by means of which a fruit or a vegetable can be cut more reliably. A further object of the invention can consist in collecting the cut material after the cutting operation.

This object is achieved by a device and by a method with one or more features of the invention. Further advantageous embodiments of the invention are described below and in the claims.

A device for processing foods comprises a container containing a dividing element for cutting through a food in order to produce a cut material, a housing for accommodating the container, and a supporting element for supporting the food. The supporting element can contain a positioning element for orienting the food in the housing. The container is rotatable in the housing. An intermediate space is provided between the supporting element and the dividing element in order to clamp the food. The food can be clamped between the supporting element and the dividing element. The dividing element is connected to the container in order to cut through the food, and therefore the cut material can be produced by means of the dividing element by a rotational movement of the container and can be guided into an interior space of the container. The cut material can be formed in particular as a strip-shaped, spiral cut material.

This device has the advantage over the prior art that the cut material is passed by the dividing element into the interior space of the container and is accommodated in the interior space of the container. Therefore, directly after the end of the dividing operation, the cut material can be dressed as desired, for example in a dish or on a plate.

The container can have a diameter of any size, and therefore not only slender, narrow, substantially rod-shaped foods, such as, for example, carrots or cucumbers, can be processed, but so too can bulbous or substantially spherical foods, such as, for example, beets, celeriac, potatoes, onions, kohlrabi and the like.

According to an exemplary embodiment, the housing is fixed in position on a base. The user can carry out the rotational movement with one hand if the housing is fixedly anchored on a base. The housing can contain a bottom element which can be held on a base by means of a negative pressure. For this purpose, the bottom element includes an elastic material which forms a cavity bounded by an edge element. If said cavity which is bounded by an edge element is placed onto a flat base, it can be subjected to a negative pressure by the air which is located in the cavity being partially removed by a temporary reduction in the volume of the cavity. The negative pressure holds the housing immovably on a base, for example on a table or on a work surface.

According to an exemplary embodiment, the container includes an exterior wall which includes a surface portion which comprises at least one of the variants of a smooth surface or an exterior thread.

According to an exemplary embodiment, the container includes a container bottom which can be closable by the dividing element. According to an exemplary embodiment, the container bottom can be formed in one piece with the dividing element. If a different cut pattern is intended to be produced, the container together with the dividing element is exchanged.

In particular, the container is open on the side opposite the container bottom, as a result of which an emptying opening is formed. The container has a casing which is substantially cylindrical or has a cylindrical portion. The container can contain a handle, wherein the handle can contain an arm element and a finger element. The arm element can be attached to the exterior wall of the container, wherein the finger element can extend from the arm element in a direction which is substantially parallel to the axis of rotation of the container.

According to an exemplary embodiment, the housing can contain a receiving area for the casing of the container, wherein the receiving area can contain a threaded portion. In particular, the receiving area can be accommodated in a ring element which is pivotable between an engagement position and a removal position.

The dividing element can contain a conical surface in which at least one cutting element is accommodated. The conical surface is in particular arranged rotationally symmetrically with respect to the axis of rotation. The point of the cone projects into the interior space of the container 2. The food can be at least partially accommodated in the cavity formed by the cone and is centered by the cone. In particular, a first dividing element and a second dividing element can be provided, wherein the first dividing element can be removable and replaceable by the second or a further dividing element.

A method for cutting through a food in order to produce a strip-shaped, spiral cut material comprises the following steps: positioning a device for processing foods on a base, removing a container from a housing, positioning a food on a supporting element, inserting a dividing element into the container. The processing of the food takes place by the following steps: positioning the container with the dividing element on the food in the housing such that the food is held or clamped between the supporting element and the dividing element and the container is accommodated in the housing, rotating the container in the housing, wherein the food is cut through by the dividing element and the strip-shaped, spiral cut material is received in the interior space of the container, removing the container together with the cut material after the end of the processing.

In particular, the ring element can be moved from the removal position into the engagement position before the rotation of the container in the housing is initiated. This method step is carried out when the container has, on its exterior wall, an exterior thread which can engage in a corresponding interior thread or an interior threaded portion of the ring element.

### BRIEF DESCRIPTION OF THE DRAWINGS

The invention is explained in more detail with reference to an illustrated exemplary embodiment, in which

FIG. 1 shows a view of a device according to an exemplary embodiment of the invention,

FIG. 2 shows an exploded illustration of the device according to FIG. 1,

FIG. 3 shows a view of the ring element according to FIG. 1 from above,

FIG. 4 shows a section through the housing of the device according to FIG. 1,

FIG. 5 shows a view of the ring element according to FIG. 1 from below,

FIG. 6 shows a view of the container according to FIG. 1,

FIG. 7a shows a view of a dividing element according to a first variant according to FIG. 1,

FIG. 7b shows a detail of FIG. 7a,

FIG. 8 shows a view of a dividing element according to a second variant according to FIG. 1,

FIG. 9 shows a view of a supporting element according to the exemplary embodiment of FIG. 1,

FIG. 10 shows a view of a device 1 according to a second exemplary embodiment of the invention,

FIG. 11 shows an exploded illustration of the device according to FIG. 10,

FIG. 12 shows a section through the housing of the device according to FIG. 10,

FIG. 13 shows a view of the container according to FIG. 10,

FIG. 14 shows a view of a dividing element according to a first variant according to FIG. 10 from the outside,

FIG. 15 shows a view of a dividing element according to a second variant according to FIG. 10 from the inside, and

FIG. 16 shows a view of a supporting element according to the exemplary embodiment of FIG. 10.

### DETAILED DESCRIPTION OF THE PREFERRED EMBODIMENTS

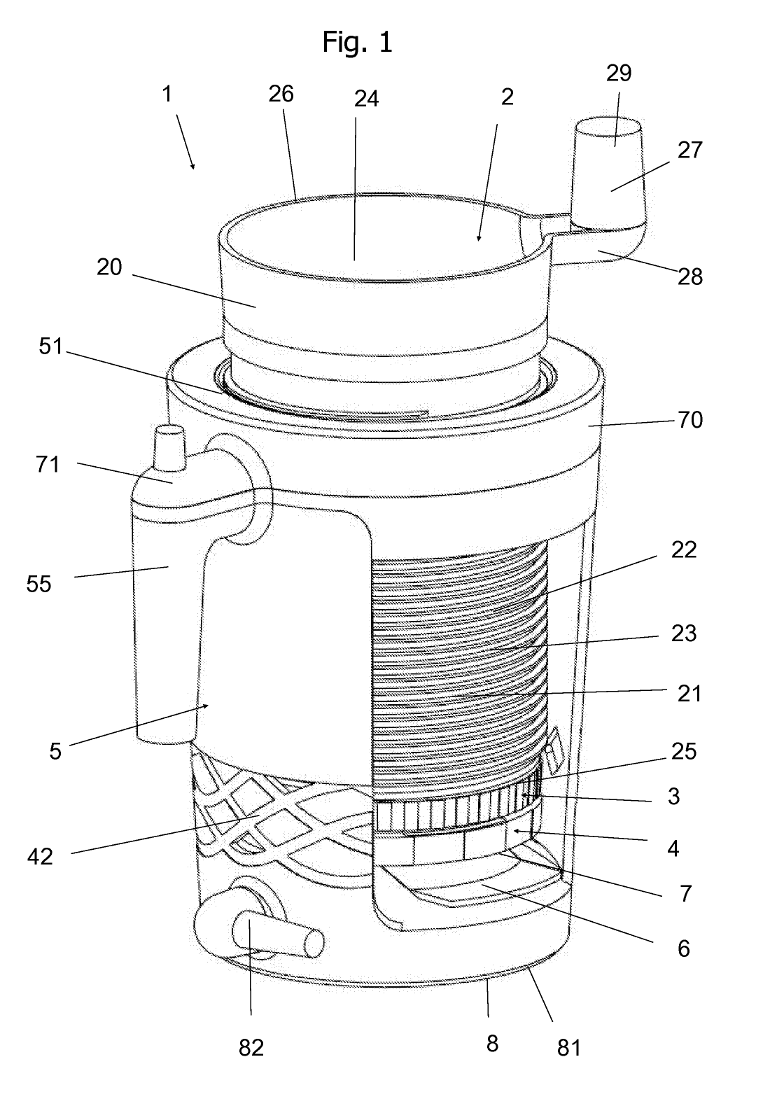

A device for processing foods, comprising a container 2 containing a dividing element 3, 4 for cutting through a food in order to produce a strip-shaped, spiral cut material is shown by reference sign 1 in FIG. 1. A housing 5 is provided for accommodating the container 2, and also a supporting element 6 is provided for supporting the food. The supporting element 6 can contain a positioning element 61 for orienting the food in the housing 5. The container 2 is rotatable in the housing 5. An intermediate space 7 is provided between the supporting element 6 and the dividing element 3, 4 in order to receive the food. The food can be clamped between the supporting element 6 and the dividing element 3, 4, wherein one of the dividing elements 3, 4 for cutting through the food is connected to the container 2, and therefore the cut material can be produced by means of the dividing element 3, 4 by a rotational movement of the container 2. In the present illustration, two dividing elements 3, 4 are shown one above the other since they can be arranged and stored in this manner when the device is not in use. This arrangement has the advantage that the dividing elements 3, 4 do not have to be kept loosely and separately, and, as a result, the risk of the dividing elements 3, 4 becoming lost is reduced.

When the device is in use, one of the dividing elements 3, 4 is selected and the other dividing element is correspondingly placed to the side. The dividing element is connected to the container 2 by being introduced into the container at the container bottom 25 and being fastened there. For this purpose, a fastening device is provided on the container bottom 25. The fastening device may be located on the interior wall in the interior space of the container 2; it may also be attached to the exterior wall 21. The fastening device can comprise a bayonette-type closure, a latching connection or a rotary closure. It is ensured by the fastening device that the dividing element 3, 4 is accommodated captively in the container bottom 25 or is attached captively to the container bottom 25, but can be removed manually again from the container bottom 25 for removing the food, for cleaning or for interchanging.

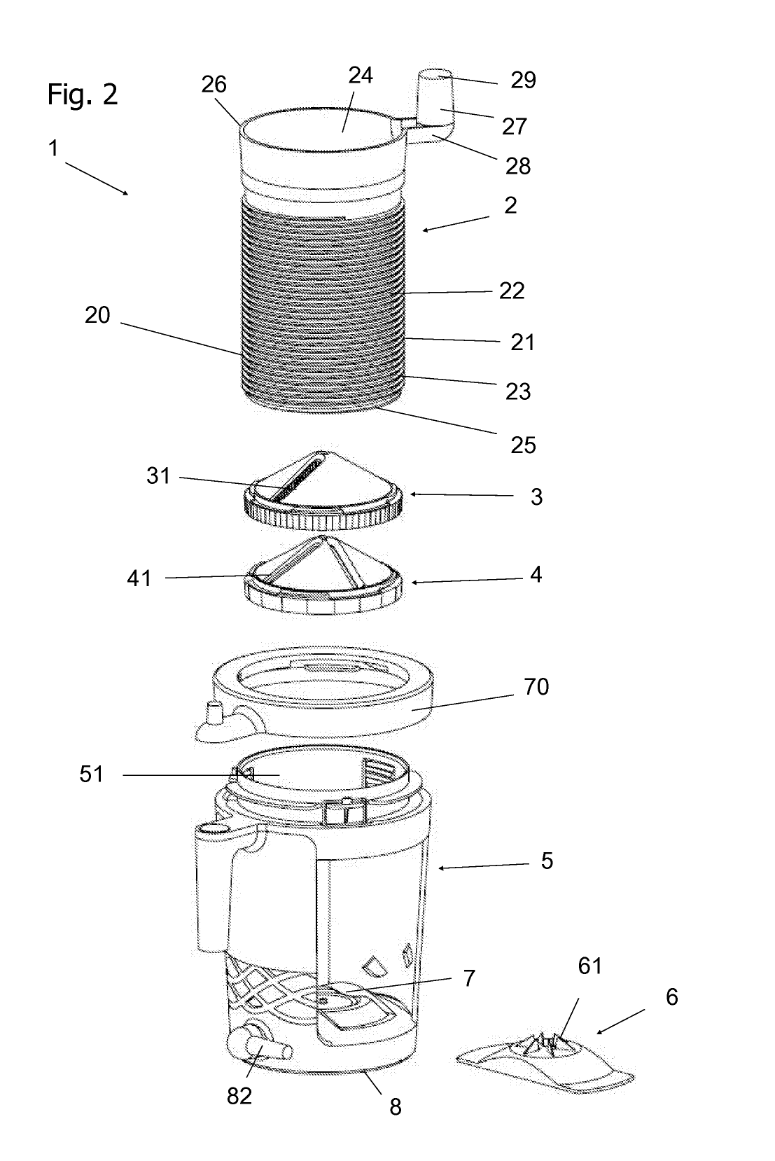

A food which is to be processed is placed on the supporting element 6 and is anchored by a positioning element 61 which is shown, for example, in FIG. 2 or FIG. 9. The positioning element 61 preferably has a plurality of cutting edges which project into the food or cut into the food and secure same against rotation or tilting.

At this point, the container 2 can be removed from the housing 5 or can be attached in the housing 5 in a position in which only a small part of the casing 20 projects into the housing 5. In particular, the container 2 can be moved toward the food until the lower side of the dividing element 3, 4 rests on the upper side of the food. The food is therefore clamped between the dividing element 3, 4 and the supporting element 6. The rotational movement of the container 2 can then be initiated. During the rotational movement of the container, the cutting element or the cutting elements 31 and/or 41 of the corresponding dividing element 3, 4 enter(s) into engagement with the food and peel(s) off a thin layer from the food. If two cutting elements are provided, two layers are accordingly peeled off. The layers can be in the form of spiral strips, ribbons or any desired further shapes and are deposited into the interior space of the container 2. The cutting element or the cutting elements 31, 41 can contain cutting edges which not only extend in the radial direction but can also be arranged in the axial direction. In particular, a combination of radially oriented and axially arranged cutting edges can be provided, and therefore a plurality of spiral strip sections can be produced. This manner of operation therefore serves for producing spaghetti-shaped food strips. If only one cutting element 31, 41 extends substantially over the entire length of the radius of the container bottom 25, strip sections having a relatively large strip width can be produced. This processing is referred to in particular in vegetable processing as Julienne.

For the rotational movement, the user can hold the housing 5 with one hand by way of the handle 55 and, with the other hand, can actuate the handle 27 on the container 2, said handle extending outward from the exterior wall 21 from the emptying opening 26 on in the radial and/or axial direction. So that the user does not have to change the hand position during the rotational movement, the handle 27 can be provided with a finger element 29 which has a rotatable cap. This rotatable cap is arranged rotatably in or on the arm element and has an axis of rotation which is preferably substantially parallel to the axis of rotation of the container 2.

The processing of the food is ended when the step 90 of the container 2 rests on the flange 74 of the ring element 70. The user can continue the rotational movement further, but the container 2 can no longer be rotated further into the housing 5, and therefore contact of the dividing element 3, 4 with the supporting element 6 or the positioning element 61 is avoided. It is thereby ensured that the dividing element 3, 4 does not come into contact with the supporting element 6.

The processed food is located in the interior space of the container 2.

The container can then be removed from the housing 5. The removal can be undertaken by rotating the container 2 back in the opposite direction.

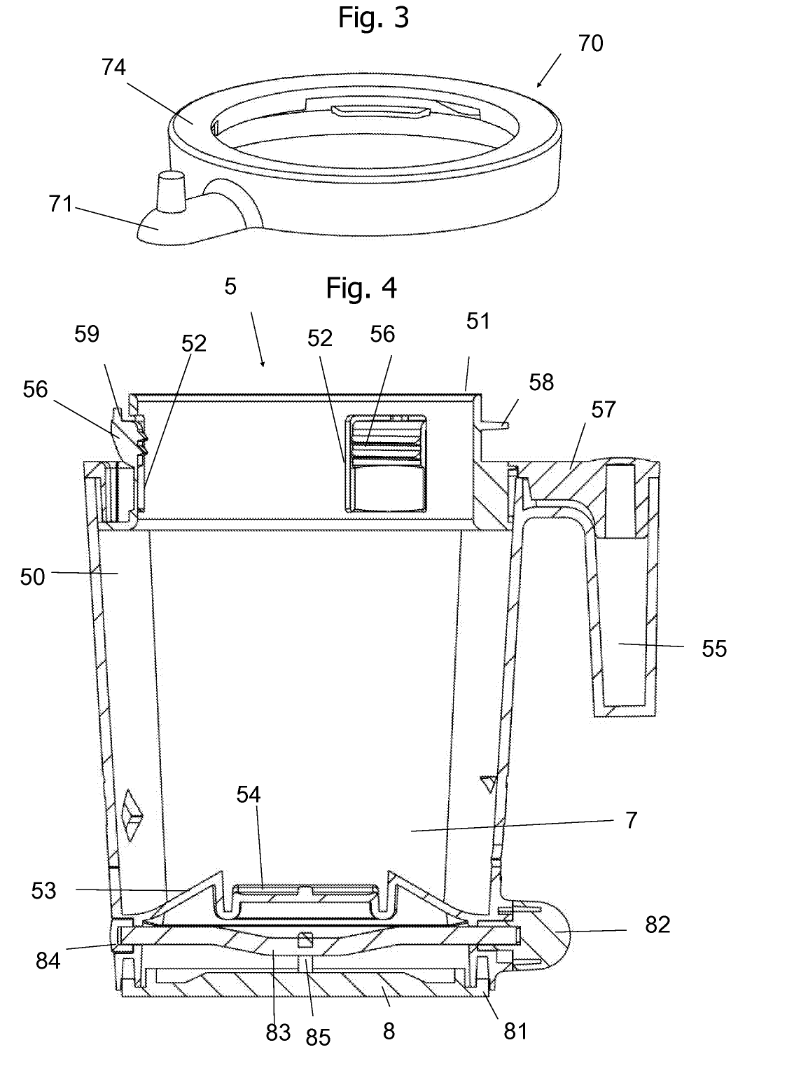

According to an exemplary embodiment, the receiving area 51 of the housing 5 can contain one or more threaded portions 56 (see FIG. 3). These threaded portions can be switchable between an engagement position and a removal position.

The user can pivot the ring element 70 about the axis of rotation of the container 2 in order to switch the threaded portion or the threaded portions 56 from the engagement position into the removal position, or vice versa.

When the threaded portion or the threaded portions 56 is or are in the removal position, the container 2 can be removed from the housing 5.

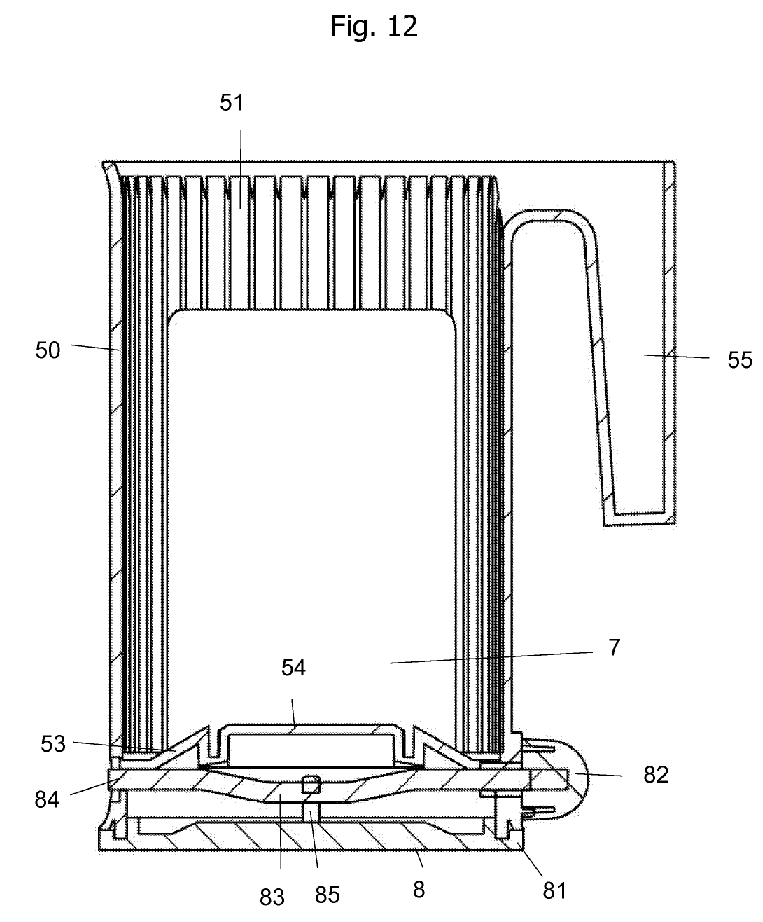

According to an exemplary embodiment, the housing 5 is in a fixed position on a base. The user can carry out the rotational movement with one hand if the housing 5 is anchored fixedly on a base. The housing 5 can contain a bottom element 8 which can be held on the base by a negative pressure. For this purpose, the bottom element 8 includes an elastic material which has a cavity which is bounded by an edge element 81 and can be subjected to a negative pressure. The bottom element 8 can be pressed in the direction of the base, for example by means of a pivot lever 82, as a result of which the volume between the bottom element 8 and the base is reduced and the air which is under positive pressure is guided past the edge element 81 into the surroundings. By this means, the housing 5 can be fastened immovably on the base, for example a table or a work surface. A pressure bar 83 which has a curved portion can be actuated by means of the pivot lever 82. The curved portion supports a pressure plunger 85 which comes into contact with the bottom element 8 when the curved portion is rotated into a position in which this curved portion is at the smallest distance from the bottom element 8. That end of the pressure bar 83 which is opposite the pivot lever 82 can be accommodated in a holding sleeve 84 which is accommodated in the housing casing 50. According to the exemplary embodiment according to FIG. 12, the holding sleeve may also be omitted. According to a further exemplary embodiment, the previously described suction device may also be dispensed with. The housing then only has the housing bottom 53.

The container 2 includes an exterior wall 21 which includes a surface portion 22 which, according to FIG. 1, comprises an exterior thread 23. The container 2 includes a container bottom 25 which is closable by the dividing element 3, 4. The container 2 is open on the side opposite the container bottom 25, as a result of which an emptying opening 26 is formed. The container 2 has a casing 20 which extends between the container bottom 25 and the emptying opening 26. The casing 20 is substantially cylindrical or has a cylindrical portion. The container includes a handle 27. The handle 27 includes an arm element 28 and a finger element 29. The arm element 28 is attached to the exterior wall 21 of the container 2, wherein the finger element 29 extends from the arm element 28 in a direction which is substantially parallel to the axis of rotation of the container 2. The finger element 29 may be mounted rotatably on the arm element 28. It is thereby ensured that the user can revolve the container 2 always with the same hand position.

The dividing element 3, 4 includes a conical surface in which at least one cutting element 31, 41 is accommodated, which is illustrated by way of example in FIG. 2. The conical surface is in particular arranged rotationally symmetrically with respect to the axis of rotation. The point of the cone projects into the interior space of the container 2. The food can be at least partially accommodated in the cavity formed by the cone and can be centered by the cone.

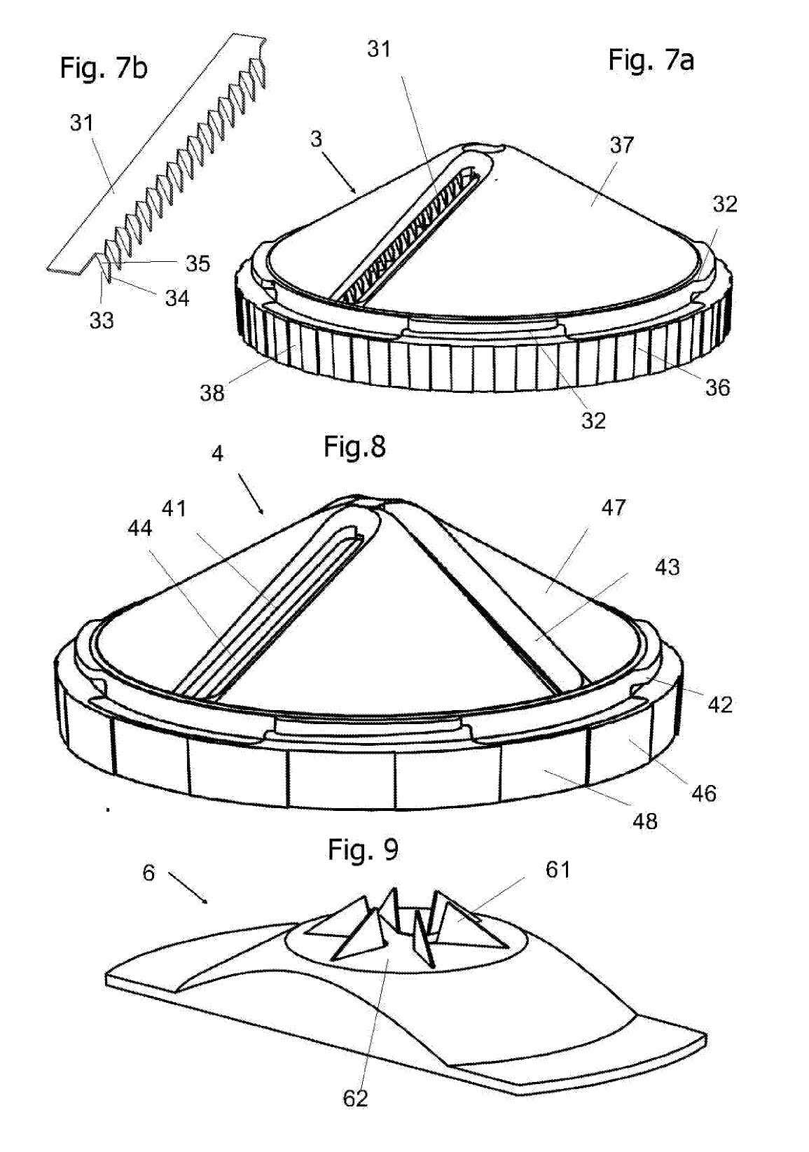

FIG. 2 illustrates the individual parts of the device 1 of FIG. 1 in an exploded drawing. The container 2 has a container bottom 25, an emptying opening 26 and a casing 20 between the container bottom 25 and the emptying opening 26. The casing 20 has a surface portion 22 on the exterior wall 21, which surface portion is provided with an exterior thread 23. The interior space 24 has a smooth surface. The container bottom can likewise be designed as an opening which comprises one or more holding elements which are not visible in this illustration. These holding elements serve for accommodating one of the dividing elements 3 or 4. The dividing element 3 has at least one cutting element 31 which is arranged on a conical surface. The dividing element 4 has at least two cutting elements 41 which are arranged on a conical surface. Each of the dividing elements 3, 4 can be accommodated in the container bottom 25 by means of a rotary closure. The dividing elements 3, 4 are illustrated in detail in FIGS. 7 and 8. The housing 5 serves for accommodating the container 2 and one of the dividing elements 3, 4 when the device is in use. The housing 5 is provided with a receiving area 51 which serves for accommodating the container 2. The receiving area 51 includes threaded portions which can be set into an engagement position or removal position by means of the ring element 70. A supporting element 6 which has a positioning element 61 in order to position the food in the housing 5 is accommodated in the housing 5.

FIG. 3 shows a view of the ring element 70 which is arranged around the receiving area 51 of the housing 5. The housing 5 has a receiving area 51 for the casing 20 of the container 2, wherein the receiving area 51 can contain a threaded portion, as is shown in FIG. 4. In the assembled state, the receiving area 51 is accommodated in the ring element 70 which is pivotable between an engagement position and a removal position.

FIG. 4 shows a section through the housing 5 of the device according to FIG. 1. The ring element 70 which is shown in FIG. 3 is left out in FIG. 4. The housing 5 has a housing casing 50 which extends between the receiving area 51 and the bottom element 8. The housing casing 50 has a first and a second opening in order to be able to position the food in the housing. The housing casing 50 merges on the lower side of the housing into a housing bottom 53. The housing bottom 53 serves for accommodating a supporting element 6 which is used for positioning the food. The supporting element 6 can easily be removed from the housing bottom 53 and cleaned or interchanged for another supporting element 6. For this purpose, the housing bottom 53 has an attachment element 54 which is designed to match a corresponding recess on the supporting element. The supporting element 6 can be held in a form-fitting manner on the attachment element 54. In order to fasten the supporting element 6 on the attachment element 54, a first and a second groove are provided in the housing bottom. According to this exemplary embodiment, the casing-side walls of the grooves have a greater height than the supporting element 6. These casing-side walls form a means for securing against rotation which prevents the supporting element 46 from being able to leave its seat on the attachment element when, by means of the rotational movement, torsional forces are introduced into the food and via the food into the positioning elements 61 of the supporting element 6.

An intermediate space 7 follows above the housing bottom 53. At the beginning of operation, said intermediate space 7 contains the food which is intended to be processed with the device. The food can be placed in the housing before the container 2 is guided with the corresponding dividing element 3, 4 through the receiving area 51. A handle 55 which simplifies the handling of the device for the user can be connected to the housing casing 50. In particular, the user can hold the handle 55 with one hand while he switches between the removal position and the engagement position by means of the ring element 70. For this purpose, the ring element 70 has a gripping arm 71 which comes to lie above the handle 55 in the engagement position, as is shown in FIG. 1. In the removal position, the gripping arm 71 does not lie above the handle 55.

In the engagement position, the threaded portions 56 engage in the exterior thread 23 of the container 2. In the removal position, the threaded portions 56 remain disengaged, and therefore the container 2 can be removed from the housing 5 without being rotated back. By this means, the user can accelerate the removal of the processed food since rotation of the exterior thread 23 of the container 2 back out of the housing 5 can be completely dispensed with.

FIG. 4 shows the removal position since the ring element 70 has been removed. The receiving area 51 is a substantially cylindrical tube element which includes a plurality of recesses 52. A threaded portion 56 which is designed as a web element with a neck element and a thickened head region is contained in each of said recesses 52. The inner side of the thickened head region includes a plurality of scores which form the threaded portion 56. The neck element is connected integrally to the receiving area 51. Since the neck element is cut out of the receiving area 51, that is to say is only still connected at its lower side to the receiving area 51, the neck element can be bent inward by a force acting from the outside. This force acting from the outside can be exerted via supporting elements which are arranged in the ring element 70.

A pin 59 can be arranged in the head region. This pin is located outside the exterior wall of the receiving area 51.

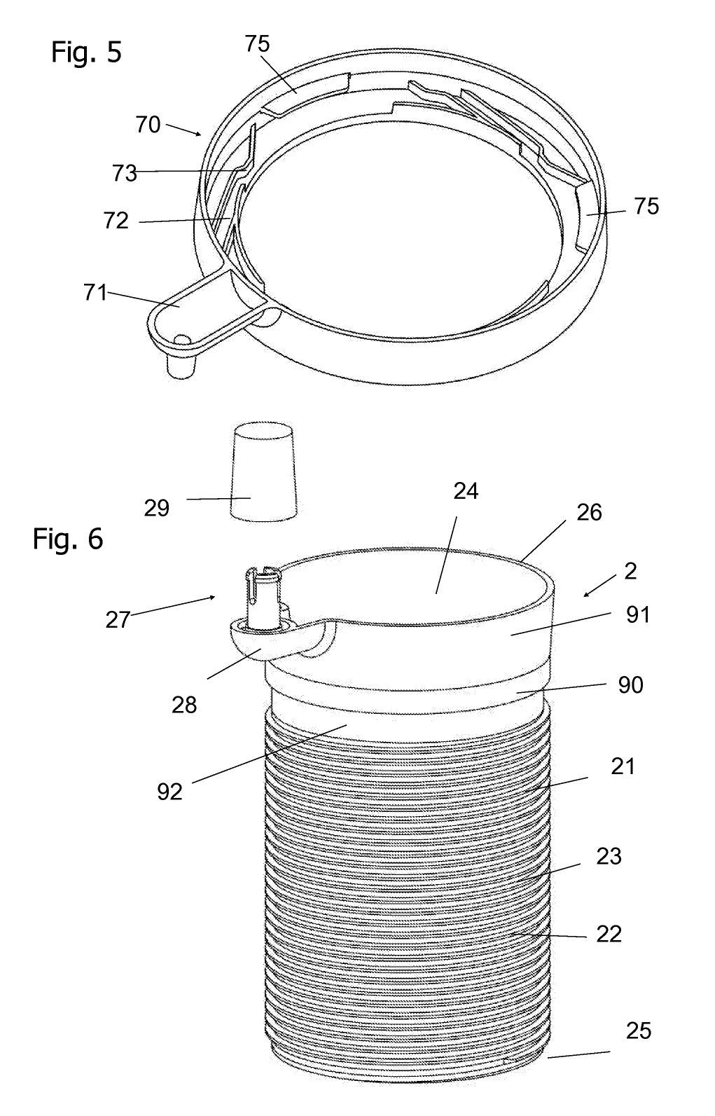

FIG. 5 shows a view of the inner side of the ring element 70. The ring element 70 includes guide channels 72 which serve for guiding a pin 59 which is arranged in the head region of the threaded portion 56 outside the receiving area 51. When the ring element 70 is moved from the removal position into the engagement position, the pin 59 slides along the guide channel 72 until said pin reaches the stop 73. In this position, the threaded portion 56 is in engagement with the exterior thread 23 or is prepared for such an engagement. The ring element 70 has a flange 74 in which the guide channel or the guide channels 72 are accommodated. The ring element 70 includes a plurality of projections 75 running on the interior wall thereof.

When the ring element 70 is located on the receiving area 51 of the housing 5, said projections engage in the holding elements 58 shown in FIG. 4.

FIG. 6 shows a view of the container according to FIG. 1. The container 2 is designed as a cylindrical, thin-walled body, the casing 20 of which bounds an interior space 24. The interior space 24 serves for receiving the processed food. The casing 20 has an exterior wall 21 which has a surface portion 22 which is at least partially provided with an exterior thread 23. The surface portion 22 can have a step 90 which is adjoined by a partial surface portion 91 with a smooth surface. The step 90 forms a stop for the flange 74 of the ring element 70. The step 90 prevents the container bottom 25 with the dividing element 3, 4 located therein from being able to come into contact with the supporting element 6. A surface partial portion 92 which does not contain a thread is located between the step 90 and the exterior thread 23. As soon as the user has advanced the rotation of the container 2 as far as the step-side end of the exterior thread, the processing of the food is finished. In this position, the container bottom 25 projects at least partially over the supporting element 6. The user can continue the rotational movement without resistance since the surface partial portion 92 does not contain a thread. The container 2 can be lowered at maximum to an extent such that the step 90 rests on the flange 74 of the ring element 70.

FIG. 7a shows a view of a dividing element 3 according to a first variant according to FIG. 1. The cutting element 31 can have at least one cutting edge; in particular, it can have precisely one cutting edge. The cutting element 31 is arranged in a recess of the conical surface 37. The cutting element 31 can also contain two or more cutting edges 33, 34. At least a first cutting edge 33 can run substantially parallel to the conical surface 37, and a second cutting edge 34 can run at an angle to the first cutting edge 33, as is illustrated in the detail of FIG. 7a that is illustrated in FIG. 7b. In particular, the first cutting edge 33 can be oriented at an angle of 70° to 90° with respect to the second cutting edge 34. The first cutting edge 33 and the second cutting edge 34 can be part of a directing element 35.

The dividing element 3 can be accommodated in the container bottom 25 by means of a rotary closure 32. The dividing element 3 can contain a cylindrical portion 38 which has a profiling 36. The profiling can supply an optical indication as to which type of processing can be carried out with the dividing element 3.

For example, the scores of the profiling 36 can be at a distance from one another which substantially corresponds to the width of the strip-shaped cut material.

The rotary closure 32 is arranged between the cylindrical portion 38 and the conical surface 37.

FIG. 8 shows a view of a dividing element 4 according to a second variant according to FIG. 1. The dividing element 4 has at least one first cutting element 41 and a second cutting element 43 which is arranged in a conical surface 47. Each of the cutting elements 41, 43 can have at least one cutting edge 44, in particular can have precisely one cutting edge. The cutting element is arranged in a conical surface 47. For this purpose, the conical surface 47 has a recess which contains the cutting element. The cutting edge 44 is arranged in such a manner that it diverts the cut material from the lower side of the conical surface 47 onto the upper side of the conical surface 47. The cutting element 41 can also have two or more cutting edges, which corresponds to the exemplary embodiment which has been described in conjunction with FIG. 7b.

The dividing element 4 can be accommodated in the container bottom 25 by means of a rotary closure 42. The dividing element 4 can contain a cylindrical portion 48 which has a profiling 46. The profiling 46 can supply an optical indication as to which type of processing can be carried out with the dividing element 4. For example, the scores of the profiling 48 can be at a distance from one another that substantially corresponds to the width of the strip-shaped cut material.

FIG. 9 shows a view of a supporting element 6 according to the exemplary embodiment of FIG. 1. The supporting element 6 is intended to be supported on the attachment element 54 which is arranged on the housing bottom 53. The supporting element 6 is configured in the shape of a dome and has a supporting plateau 62 which includes the positioning elements 61. The positioning elements are designed as triangular, sharp-edged points on which the food can be skewed. Alternatively, spear-shaped points, square or other thin-walled, sharp-edged projections could be provided. In particular, projections with a surface extent can be provided, said projections forming a good lateral supporting surface and therefore having an increased resistance to rotation. In particular, the positioning elements can be arranged at different angles from one another. By means of the cutting elements 31, 41, 43, torsional forces are introduced into the food, which torsional forces could lead to the food being able to rotate too on the supporting plateau if the cutting element provide too small a resistance, if any at all, to the torsional forces. However, if the food carries out the rotational movement of the container 2, which may occur in the case of foods which are processed with a device according to the prior art, the food is no longer cut and, instead, is pressed by the dividing element 3, 4. If the dividing element does not have a conical surface and/or the cutting elements have obtuse cutting edges, the food is not processed correctly, but rather is converted into a pulpy mass or the food may slide away.

The conical surfaces 37, 47 of the dividing elements 3, 4 can enclose an angle of inclination with the axis of rotation that amounts to 25° to 80°, preferably 30° to 75°.

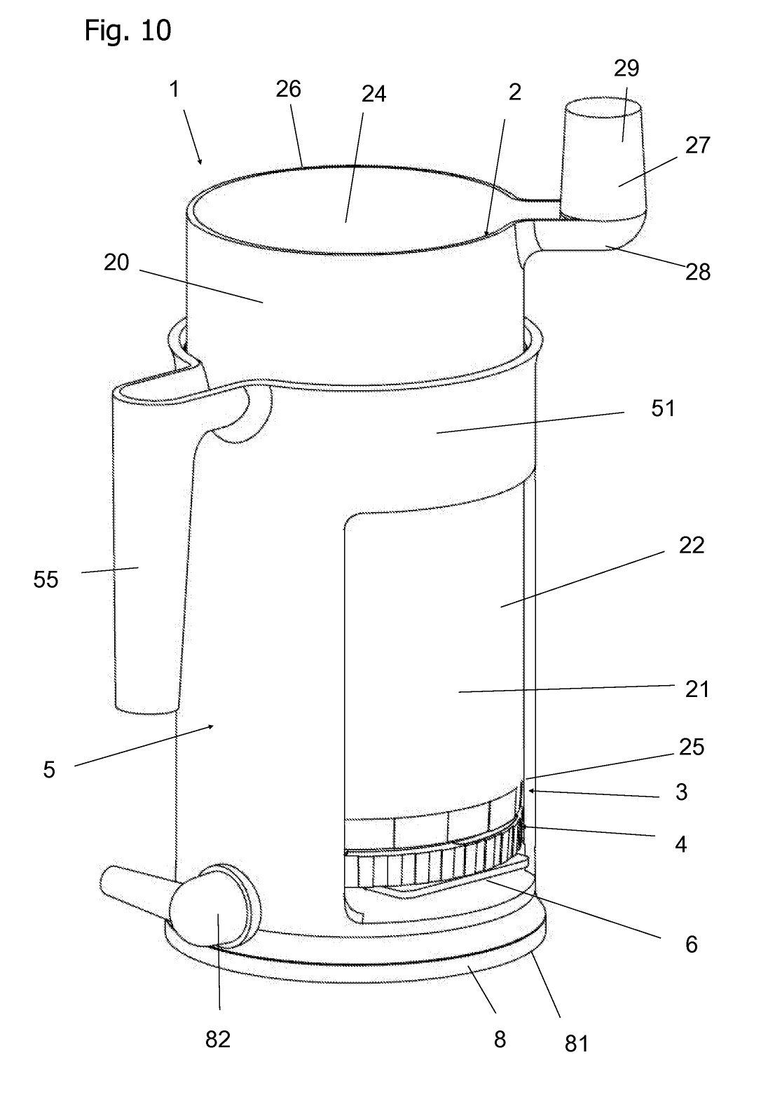

FIG. 10 shows a view of a device according to a second exemplary embodiment of the invention. Elements configured identically to their configuration in the preceding exemplary embodiment are provided with the same reference signs and reference is made to the description with regard to FIGS. 1-9. Further statements are made below only with regard to the elements which differentiate this exemplary embodiment from the first exemplary embodiment.

The second exemplary embodiment differs from the first exemplary embodiment to the effect that the container 2 has a casing 20 which has an exterior wall 21 which has a smooth surface. The exterior wall 21 is therefore freely rotatable in the housing 5. The contact pressure exerted by the dividing element 3 or 4, which is connected to the container 2, on the food can therefore be varied depending on the consistency of the food.

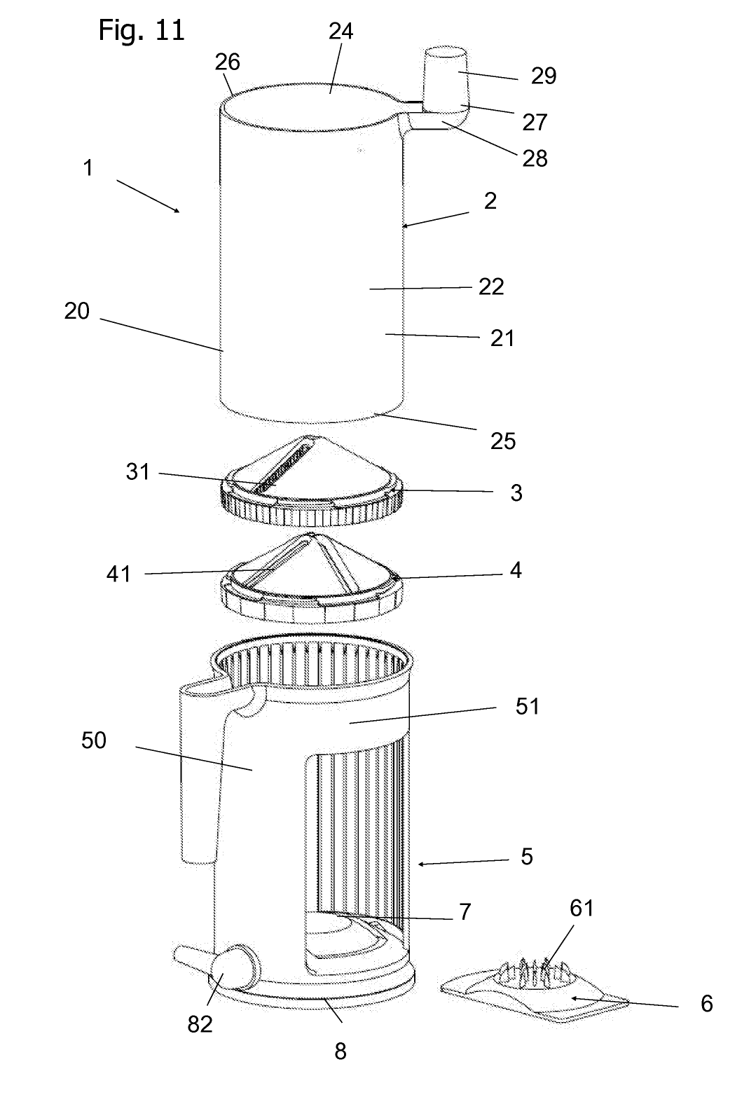

FIG. 11 shows an exploded illustration of the device according to FIG. 10, in which the arrangement of the device components shown in FIG. 10 are visible. In particular, FIG. 11 shows a view of the container 2, the exterior wall 21 of which has a smooth surface. The container 2 is a cylindrical tube which has a casing 20 which extends from the container bottom 25 to the emptying opening 26. As in the exemplary embodiment according to FIGS. 1-9, the container bottom has a receiving element (not illustrated) for one of the dividing elements 3, 4, which correspond to the dividing elements according to FIG. 7a, FIG. 7b or FIG. 8. The housing 5 has a cylindrical housing casing 50 which, as in the first exemplary embodiment, includes two opposite openings which serve for the positioning of the food.

FIG. 12 shows a section through the housing of the device according to FIG. 10. In contrast to the exemplary embodiment according to FIG. 4, a ring element 70 is not required since the container 2 does not have an exterior thread which would have to engage in an associated interior thread. The housing 5 has a housing casing 50 which extends between the receiving area 51 and the bottom element 8. The housing casing 50 has a first and a second opening in order to be able to position the food in the housing. The housing casing 50 merges on the lower side of the housing into a housing bottom 53. The housing bottom 53 serves for accommodating a supporting element 6 which is used for positioning the food. The supporting element 6 can easily be removed from the housing bottom 53 and cleaned or interchanged for another supporting element 6. For this purpose, the housing bottom 53 includes an attachment element 54 which is designed to match a corresponding recess on the supporting element. The supporting element 6 can be held in a form-fitting manner on the attachment element 54. In order to fasten the supporting element 6 on the attachment element 54, a first and a second groove are provided in the housing bottom. According to this exemplary embodiment, the casing-side walls of the groove have substantially the same height as the supporting element 6. A device according to the second exemplary embodiment can be used in particular for foods which have a lower dividing resistance than the foods which are processed with the device according to one of FIGS. 1-9. Smaller torsional forces therefore act on the supporting element 6 and on the attachment element 54. The device according to FIG. 12 can therefore be realized without an additional means for securing against a rotation for the supporting element 6.

An intermediate space 7 follows above the housing bottom 53. At the beginning of operation, said intermediate space 7 contains the food which is intended to be processed with the device. The food can be placed in the housing before the container 2 is guided with the corresponding dividing element 3, 4 through the receiving area 51. A handle 55 which simplifies the handling of the device for the user can be connected to the housing casing 50. In particular, the user can hold the handle 55 with one hand while he positions the container 2 and sets same into a rotational movement by means of the other hand.

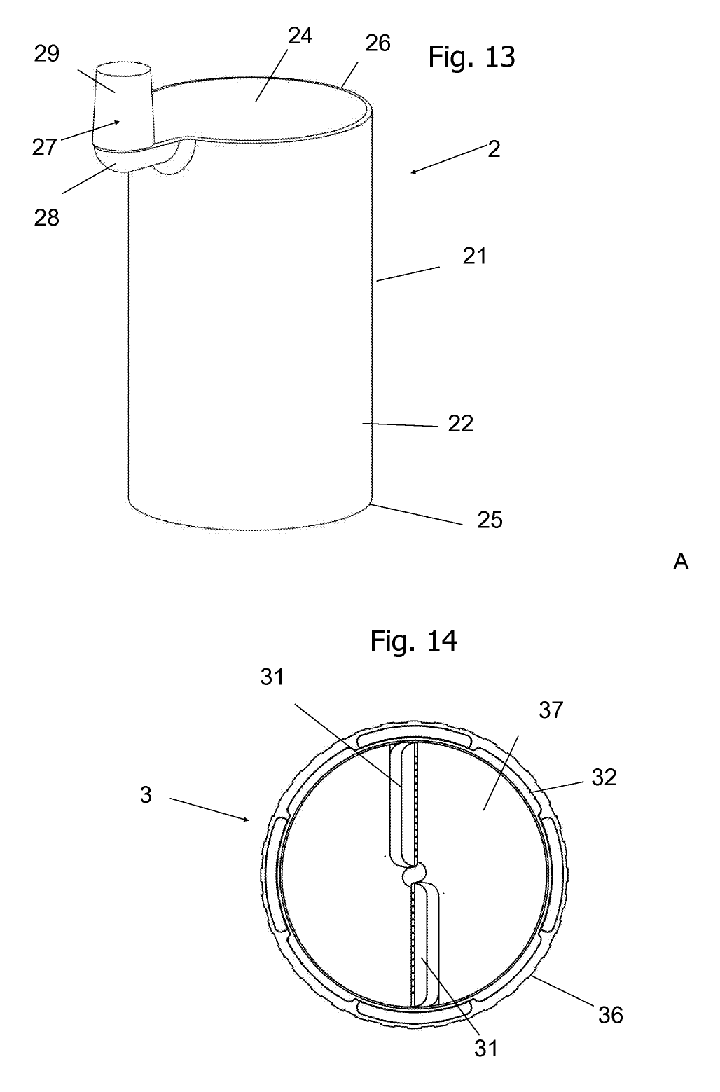

FIG. 13 shows a view of the container according to FIG. 10. The container 2 is designed as a cylindrical, thin-walled body, the casing 20 of which bounds an interior space 24. The interior space 24 serves for receiving the processed food. The casing 20 has an exterior wall 21 which has a surface portion 22. The surface portion 22 can be formed without steps or projections, with the exception of a handle 27 which is arranged on the edge of the removal opening 26 and the design of which corresponds to the handle of FIG. 6. The container bottom 25 includes a receiving element for one of the dividing elements 3, 4, as shown in FIG. 7a, FIG. 7b, FIG. 8, FIG. 14, or FIG. 15.

When the processing of the food is finished, the lower side of the dividing element can rest on the supporting element 6, and therefore the intermediate space 7 disappears. In this position, the container bottom 25 projects at least partially over the supporting element 6. The user can continue the rotational movement without resistance since the supporting element 6 is designed in the shape of a dome and includes a supporting plateau 62 which bears the positioning elements 61. The conical surface 37, 47 of the dividing element 3, 4 therefore does not come into contact with the positioning elements, and therefore the container 2 or the dividing element 3, 4 can come into contact with the housing bottom 53 or the supporting element 6. When the dividing element 3, 4 rests on the housing bottom 53, the processing of the food is finished and the container 2 can be removed from the housing 5.

FIG. 14 shows a view of a dividing element 3 according to a first variant according to FIG. 10 from above, that is to say from the side on which the processed food comes to lie in the operating state. The dividing element 3 includes two cutting elements 31 which are arranged in recesses of the conical surface 37. The dividing element 3 corresponds to the dividing element 3 according to FIG. 7a. According to an exemplary embodiments (not illustrated in the drawings), the blade can be arranged parallel to the cutting surface.

FIG. 15 shows a view of a dividing element 4 according to a second variant according to FIG. 10 from the inside, that is to say, from the side which lies opposite the supporting element 6. The dividing element 4 has a first pair of cutting elements 41 and a second pair of cutting elements 43. Each of said cutting elements 41, 43 has a cutting edge 44 which is arranged in a recess. The rotary closure 42 is not visible in this view. A spike element 40 can be arranged in the point of the conical surface 47. This spike element 40 can pierce the food in order to center the food and to hold the food in its position between the dividing element 4 and the supporting element 6. Of course, a spike element of this type may also be provided on the dividing element 3, and also for a further dividing element configured as desired. The spike element may also have lateral wings for boring into the food.

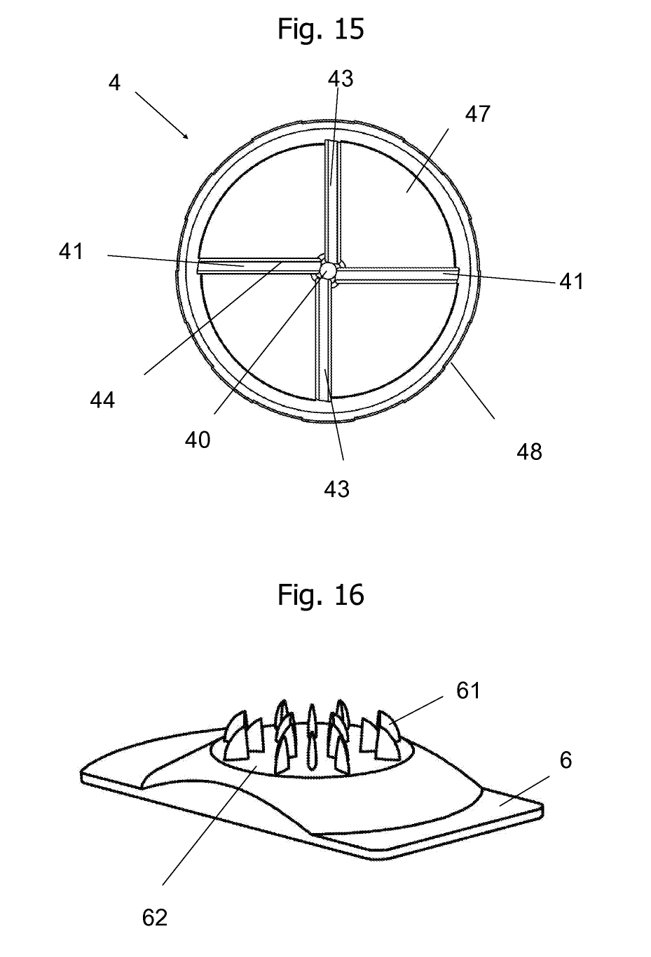

FIG. 16 shows a view of a supporting element 6 according to the exemplary embodiment of FIG. 10. The supporting element 6 according to this exemplary embodiment differs by the number, arrangement and shape of the positioning elements 61. At least some of the positioning elements 61 have in particular a curved edge. The curved edges of the positioning elements point in particular outward, that is to say in the direction of the interior wall of the housing 5, and therefore the positioning elements cannot come into contact with the interior wall of the conical surface when the container comes to lie in or on the housing bottom 53. The positioning elements 61 shown merely constitute a selection of possible shapes of positioning elements.

A method for cutting through a food in order to produce a strip-shaped, in particular spiral, cut material comprises the following steps: positioning a device 1 for processing foods on a base, removing a container 2 from a housing 5, positioning a food on a supporting element 6, inserting a dividing element 3, 4 into the container 2. The food is processed by the following steps:

positioning the container 2 with the dividing element 3,4 or a further dividing element of any desired configuration on the food in the housing 5 such that the food is held or clamped between the supporting element 6 and the dividing element 3,4 and the container 2 is accommodated in the housing 5, rotating the container 2 in the housing 5, wherein the food is cut through by the dividing element 3,4 and the strip-shaped, spiral cut material is received in the interior space of the container 2, removing the container 2 together with the cut material after the end of the processing. In particular, the housing 5 can have a rotatable ring element 70, wherein the ring element 70 is moved from the removal position into the engagement position before the rotation of the container in the housing is initiated, and therefore the interior thread of the ring element 70 enters into engagement with the exterior thread 23 of the container 2. This method step is carried out when the container 2 has, on its exterior wall 21, an exterior thread 23 which can engage in a corresponding interior thread or an interior threaded portion of the ring element 70.

It is obvious to a person skilled in the art that many further modifications are possible in addition to the exemplary embodiments described without departing from the inventive concept. The subject matter of the invention is therefore not restricted by the description above and is defined by the scope of protection which is established by the claims. For the interpretation of the claims or of the description, the broadest possible manner of reading the claims is crucial. In particular, the terms “contain” or “include” are intended to be interpreted in such a manner that they relate to elements, components or steps in a non-exclusive meaning, as a result of which it is intended to be indicated that the elements, components or steps may be present or may be used, and that they may be combined with other elements, components or steps which are not explicitly mentioned. If the claims relate to an element or to a component from a group which can consist of A, B, C . . . . N elements or components, this wording is intended to be interpreted to the effect that only a single element of this group is required, and not a combination of A and N, B and N or any other combination of two or more elements or components of this group.

1. A device (1) for processing foods, comprising a container (2) containing a dividing element (3, 4) for cutting through a food in order to produce a strip-shaped, spiral cut material, a housing (5) for accommodating the container (2), a supporting element (6) for supporting the food, the container (2) is rotatable in the housing (5), an intermediate space (7) is provided between the supporting element (6) and the dividing element (3, 4) in order to clamp the food, the dividing element (3, 4) is connected to the container (2) for cutting through the food, and therefore the cut material produced by the dividing element (3, 4) by a rotational movement of the container (2) is guided into an interior space (24) of the container (2).

2. The device according to claim 1, wherein the housing (5) is fixed in position.

3. The device according to claim 1, wherein the container (2) includes an exterior wall (21) which includes a surface portion (22) which comprises at least one of a smooth surface or an exterior thread (23).

4. The device according to claim 1, wherein the container (2) includes a container bottom which is closable by the dividing element (3, 4).

5. The device according to claim 1, wherein the housing (5) has a receiving area (51) for the casing (20) of the container (2), and the receiving area (51) includes a threaded portion.

6. The device according to claim 5, wherein the receiving area (51) is accommodated in a ring element (70) which is pivotable between an engagement position and a removal position.

7. The device according to claim 1, wherein the dividing element (3, 4) includes a conical surface in which at least one cutting element (31, 41) is accommodated.

8. The device according to claim 1, wherein a first dividing element (3) and a second dividing element are provided, and the first dividing element (3) is removable and replaceable by the second dividing element (4).

9. A method for cutting through a food in order to produce a strip-shaped, spiral cut material, comprising the following steps:
positioning a device (1) for processing foods on a base,
removing a container (2) from a housing (5),
positioning a food on a supporting element (6),
inserting a dividing element (3, 4) into the container (2),
positioning the container (2) with the dividing element (3, 4) on the food in the housing (5) such that the food is held or clamped between the supporting element (6) and the dividing element (3, 4) and the container (2) is accommodated in the housing (5),
rotating the container (2) in the housing (5), wherein the food is cut through by the dividing element (3, 4) and the strip-shaped, spiral cut material is received in the interior space of the container (2), and
removing the container (2) together with the cut material after the end of the processing.

10. The method according to claim 9, wherein the housing (5) includes a ring element (70) which is moved from a removal position into an engagement position before initiating rotation of the container (2) in the housing (5).
